(19) United States
(12) Patent Application Publication
(10) Pub. No.: US 2008/0233409 A1
(43) Pub. Date: Sep. 25, 2008

(54) Method for manufacturing substrate for making microarray

(75) Inventors: Wataru Kusaki, Niigata (JP); Takeshi Kinsho, Niigata (JP); Toshinobu Ishihara, Niigata (JP)

Correspondence Address: OLIFF & BERRIDGE, PLC, P.O. BOX 320850, ALEXANDRIA, VA, 22320-4850, US

(73) Assignee: SHIN-ETSU CHEMICAL CO., LTD., Tokyo (JP)

(21) Appl. No.: 12/071,885

(22) Filed: Feb. 27, 2008

(30) Foreign Application Priority Data
Mar. 22, 2007 (JP) 2007-75386

(51) Int. Cl. B32B 9/04

(52) U.S. Cl. 428/447

(57) ABSTRACT

A method for manufacturing a substrate for making a microarray, in which a monomolecular film is not detached when a target molecule is immobilized on the substrate using the monomolecular film having a silicon oxide chain is provided.

A method for manufacturing a substrate for making a microarray comprising; at least a step of forming a monomolecular film on the substrate using a silane compound, wherein the monomolecular film is formed using a solution comprising the silane compound and a nitrogen-containing organic base in the step.

### BACKGROUND OF THE INVENTION

1. Field of the Invention

The present invention relates to analysis technology involved in gene sequences in analyses of biologically functional molecules, particularly DNA sequences and in genetic diagnosis, and a method for manufacturing a substrate for making a device for analysis used for those analyses.

2. Description of the Related Art

The analysis technology for DNA sequences of genes including human genomic analysis has been advanced rapidly in recent years, and has been developed for the study on gene functions and diagnosis of diseases by the gene based on those information. Numerous studies on so-called DNA chips, DNA microarrays as the technology for performing these analyses and functional studies of the genes on a large scale in a short time have been performed.

In the DNA microarray, DNA having the particular sequence is immobilized in a microspace and a DNA strand having a complementary sequence in a sample is detected. As a methodology for making the DNA microarray capable of processing on a large scale and with high speed, a method of making the microarray modified with various DNA in surprisingly few steps by performing a position-selective synthesis of DNA sequences over multiple stages using photolithography which is a method for making a semiconductor has been proposed in CHEMTECH February 1997, pp. 22. According to this, a possibility has been shown that the microarray for examining more than one billion DNA sequences at the same time can be make by repeating binding of methodically and position-selectively different nucleotides 15 times.

Meanwhile, if the DNA strand having the above complementary sequence can be electrically detected, it becomes possible to analyze by a high speed and simple method. Domestic Re-publication of WO2003/087798 and JP 2005-77210-A have been already known as attempts to make the microarray using a semiconductor apparatus for the purpose of such an electric detection. In these semiconductor apparatuses, the presence or absence of the complementary DNA strand is detected on a microchip as a practical application of a sensor by a field effect transistor known conventionally.

By the way, to make the DNA microarray capable of analyzing on a large scale and with high speed, it is necessary to immobilize the DNA strand on the substrate for making the microarray position-selectively to the microspace and not to cause problems such as detachment. In order to analyze the biologically functional molecules including DNA molecules, as the method for two-dimensionally immobilizing them on a metal, the method of using specific absorption of a sulfur atom on a gold surface is known and described in, for example, Domestic Re-publication of WO2003/087798. Meanwhile, the method in which a monomolecular film having a silicon oxide chain is formed on the substrate so that the immobilized molecule is not detached and an enzyme is certainly immobilized on the semiconductor, and the enzyme is immobilized on an alkyl chain extending from a silicon atom has been known quite some time ago, and disclosed in Japanese Patent Laid-open (Kokai) No. 62-50657-A. This method is also mentioned to be applicable in the above Japanese Patent Laid-open (Kokai) No. 2005-77210-A.

It has been already known publicly that when the monomolecular film using an alkoxysilane compound is formed on the substrate, a metal salt is used as a catalyst of silanol condensation (Japanese Patent Laid-open (Kokai) No. 4-221630-A). Meanwhile, it has been known that when a titanate compound and water are added to the alkoxysilane compound, silanolation is catalyzed (Mat. Res. Soc. Symp. Proc., Vol. 847, EE9.16).

However, as a result of the present inventors' investigation, it was confirmed that in the case of forming the monomolecular film by the existing method such as those in Japanese Patent Laid-open (Kokai) No. 8-337654-A and Mat. Res. Soc. Symp. Proc., Vol. 847, EE9.16, when a process manipulation of post-modifying the alkyl chain extending from the silicon atom with an enzyme, DNA or an alkyl chain was performed, the monomolecular film was detached. Meanwhile, even if the monomolecular film is attempted to be formed without using the catalyst shown in Japanese Patent Laid-open (Kokai) No. 8-337654-A and Mat. Res. Soc. Symp. Proc., Vol. 847, EE9.16, it has been confirmed that the sufficiently dense and workable monomolecular film is not obtained.

Therefore, when a target molecule is immobilized on the substrate using the monomolecular film having the silicon oxide chain, the substrate for making the microarray where the monomolecular film is not detached has been required.

### SUMMARY OF THE INVENTION

The present invention has been made in the light of the above circumstance, and aims at providing a method for manufacturing a substrate for making a microarray, in which a monomolecular film is not detached when a target molecule is immobilized on the substrate using the monomolecular film having a silicon oxide chain.

The present invention has been made for solving the above problem, and provides the method for manufacturing the substrate for making the microarray comprising; at least a step of forming the monomolecular film on the substrate using a silane compound, wherein the monomolecular film is formed in the step using a solution containing the silane compound and a nitrogen-containing organic base.

This way, by adding the nitrogen-containing organic base to materials for forming the monomolecular film, it is possible to obtain the monomolecular film which is hardly detached upon processing such as immobilization of the target molecule. Thus, detachment of the immobilized material is prevented, and it is possible to obtain the substrate for making the microarray with high quality where finer process with high accuracy can be performed.

In this case, as the nitrogen-containing organic base, it is preferable to use the nitrogen-containing organic base containing the following structural formula (1) in its structure.

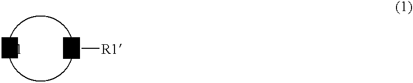

In the formula, R1 represents a linear, cyclic or branched alkylene group having 2 to 20 carbon atoms and may comprise one or more of a carbonyl group, an ether group, an ester group, and a sulfide group; and R1′ represents hydrogen or a linear or branched alkyl group having 1-25 carbon atoms and may comprise one or more of a carbonyl group, an ether group, an ester group and a lactone ring.

Furthermore, it is preferable to use the nitrogen-containing organic base having a cyclic structure because the monomolecular film is easily formed.

Among them, it is preferable to use a pyrrolidine derivative or a piperidine derivative as the nitrogen-containing organic base.

This way, it is preferable to use the pyrrolidine derivative or the piperidine derivative as the nitrogen-containing organic base because the monomolecular film is more easily formed.

For a concentration ratio of the silane compound to the nitrogen-containing organic base, it is preferable to make a molar ratio of the nitrogen-containing organic base to be 0.1 to 100 relative to 1 of the silane compound.

This way, it is preferable to make the molar ratio of the nitrogen-containing organic base to be 0.1 to 100 relative to 1 of the silane compound for the concentration ratio of the silane compound to the nitrogen-containing organic base because the monomolecular film is formed more easily.

The microarray can be used for the analyses of biomolecules.

This way, the microarray can be used for the analyses involved in the gene sequences in analyses of biologically functional molecules, particularly DNA sequence analyses and in genetic diagnosis.

As described above, by the use of the method for manufacturing the substrate for making the microarray of the present invention, the substrate for the microarray, where the detachment of the immobilized material is prevented and the finer process with high accuracy can be performed upon processing is obtained easily and simply.

### BRIEF DESCRIPTION OF THE DRAWINGS

FIG. 1 is a schematic view showing one example of a method for manufacturing a substrate for making a microarray according to the present invention.

### DESCRIPTION OF THE INVENTION AND A PREFERRED EMBODIMENT

Embodiments of the present invention will be described below, but the present invention is not limited thereto.

As described above, as a result of the present inventors' investigation, it was confirmed that in the case of forming the monomolecular film by the existing method such as those in Japanese Patent Laid-open (Kokai) No. 8-337654-A and Mat. Res. Soc. Symp. Proc., Vol. 847, EE9.16, when the process manipulation of post-modification with an enzyme, DNA or an alkyl chain was performed to the alkyl chain extending from a silicon atom, the monomolecular film was detached. Meanwhile, even if the monomolecular film is attempted to be formed without using the catalyst shown in Japanese Patent Laid-open (Kokai) No. 8-337654-A and Mat. Res. Soc. Symp. Proc., Vol. 847, EE9.16, it has been confirmed that the sufficiently dense and workable monomolecular film is not obtained.

For solving the above problems, the present inventors studied extensively, have thought of that a monomolecular film which is hardly detached upon processing such as immobilization of the target molecule can be obtained and further even when the metal catalyst shown in Japanese Patent Laid-open (Kokai) No. 8-337654-A and Mat. Res. Soc. Symp. Proc., Vol. 847, EE9.16, is used, no metal remains on the substrate and the dense monomolecular film is obtained by adding a nitrogen-containing organic base to the material for forming the monomolecular film, and have completed the present invention.

That is, the present invention provides the method for manufacturing the substrate for making the microarray comprising; at least a step of forming the monomolecular film on the substrate using the silane compound, wherein the monomolecular film is formed in the step using the solution containing the silane compound and the nitrogen-containing organic base.

The microarray manufactured by the substrate for making the microarray of the present invention is particularly preferably applied when manufacturing the substrate for making the microarray by applying the method of present invention which is not limited to a fluorescence method, an electric method and the like on a semiconductor apparatus as a principle for the method of acquiring data.

When the analysis is performed by the electric method using the semiconductor apparatus, as the semiconductor apparatus, the method of immobilizing on a capacitor as shown in Domestic Re-publication of WO2003/087798 and the method of immobilizing to a gate electrode or the surface of a floating electrode connected to the gate electrode as shown in Japanese patent Laid-open (Kokai) No. 2005-77210-A are known.

When the method of the present invention is used, in the case where an outmost surface of the material for the immobilization is a metal oxidized film, the hydroxyl group on the surface is sufficient and the surface is directly treated with a silicon compound described later, thereby being possible to form the monomolecular film having the silicon oxide chain. When the outmost layer is a metal film, a spontaneously oxidized film on the outmost layer may be used, or only a proximity of a surface layer may be oxidized with such as ozone, hydrogen peroxide, water, oxygen plasma to apply. In the method for detection not dependent on the electric method, it is also conceivable to apply on a resin substrate. In such a case, it is disclosed in Japanese Patent Laid-open (Kokai) No. 4-221630-A that the monomolecular film having the silicon oxide chain can be formed by treating the surface with electron beams or ion beams in an oxygen atmosphere.

The monomolecular film may be formed on an entire region of the substrate, but it is common to form on only a required region, and the monomolecular film can be formed position-selectively using the resist film. This manipulation is known well, and the resist used here is not particularly limited, but in order to selectively process in a finer position, it is preferable to use a chemically amplified type resist.

As the chemically amplified resist used here, it is preferable that the monomolecular film is not formed on the resist film in the step of forming the monomolecular film. It is preferable that the resin used for the resist material contains 5% or less polymerization unit containing hydroxyl group. It is more preferable that the unit having the hydroxyl group is not contained. Thus, also in this sense, it is preferable to select the chemically amplified positive resist rather than a novolak based resist where the presence of the hydroxyl group is essential on its mechanism or a negative type resist where solubility is changed by crosslinking based on the hydroxyl group, as the type of the resist.

As the resin used for the positive resist where the presence of the hydroxyl group is not essential on its principle as the above, it is preferable to use a polymer obtained by combining the unit having an acidic functional group protected with an acid degradable protecting group and a so-called adhesive group developed for ArF excimer laser.

As the unit having the acidic functional group protected with the acid degradable protecting group, it is possible to use the unit having a phenolic hydroxyl group protected with a tertiary alkyl group, a tertiary alkoxycarbonyl group or an acetal group, more specifically, the unit having protected vinylphenol as well as a protected carboxyl group, and more specifically protected vinyl benzoate and (meth)acrylic acid. Many of these have been already known publicly (e.g., Japanese Patent Laid-open (Kokai) No. 2006-225476-A, Japanese Patent Laid-open (Kokai) No. 2006-328259-A).

The so-called adhesive group developed for the ArF excimer laser is the unit having a cyclic ether structure or a lactone structure in the unit, and particularly the unit having the lactone structure has a large effect. Many of these have been already known publicly (e.g., Japanese Patent Laid-open (Kokai) No. 2006-328259-A).

For a polymerization ratio of the above two units, if the unit having the acidic functional group protected with the acid degradable protecting group is contained at 20 mole % or more, it is less likely to reduce a resolution, and if the unit having the adhesive group is contained at 40 mole % or more, it is less likely to cause a detachment problem.

An acid generator, and if necessary a basic substance and a surfactant are further added to the composition for forming the resist film, and many of them have been already known publicly (e.g., Japanese Patent Laid-open (Kokai) No. 2006-225476-A, Japanese Patent Laid-open (Kokai) No. 2006-328259-A). Any of them can be used basically. The methods for forming the resist pattern have been also already known publicly, and by applying them, it is possible to mask only the region required to be masked.

In the step of forming the monomolecular film having the silicon oxide chain, the monomolecular film is formed by treating the non-coated substrate on which the resist pattern which protects a face other than the region to which the material for recognition will be immobilized has been formed or the resist pattern has not been provided when the entire region may be treated, with for example, a treating solution containing the silicon compound represented by the following formula (A):

Y′₃Si—(CH₂)ₘ—X′ (A)

wherein m represents an integer of 3 or more, X′ denotes a hydroxyl group precursor functional group, and Y′ independently denotes a halogen atom or an alkoxy group having 1-4 carbon atoms, and the nitrogen-containing organic base.

In the above formula, if m is the integer of 3 or more, the monomolecular film can be formed. However, as described later, when the method of making a space for the material to be immobilized is applied, m is preferably 5 or more and more preferably 8 or more.

The hydroxyl group precursor functional group X′ is the hydroxyl group protected with the so-called protecting group or vicinal diol. Many of such protecting groups are known publicly, and representatives thereof can include acyl, oxyranyl and acetal groups. In the later step, the particular region on the monomolecular film is masked using the resist in order to immobilize the material for recognition to only the particular-region on the resulting monomolecular film. When the chemically amplified type resist is used here, it is preferable that the monomolecular film is not contaminated with the basic substance and capable of being deprotected by acidic treatment. Those capable of being deprotected under an acidic condition include oxyranyl and acetal groups in the above. Among the acetal groups, when X′ is a methoxymethoxy group or an oxyranyl group, the monomolecular film is easily formed because the groups are sterically small.

According to the present invention, examples of the nitrogen-containing organic base used when the monomolecular film is formed include primary, secondary and tertiary aliphatic amines, mixed amines, aromatic amines, heterocyclic amines, nitrogen-containing compounds having carboxy group, nitrogen-containing compounds having sulfonyl group, nitrogen-containing compounds having hydroxyl group, nitrogen-containing compounds having hydroxyphenyl group, alcoholic nitrogen-containing compounds, amides, imides, and carbamates.

Specifically, as primary aliphatic amines, for example, ammonia, methylamine, ethylamine, n-propylamine, isopropylamine, n-butylamine, isobutylamine, sec-butylamine, tert-butylamine, pentylamine, tert-amylamine, cyclopentylamine, hexylamine, cyclohexylamine, heptylamine, octylamine, nonylamine, decylamine, dodecylamine, cetylamine, methylenediamine, ethylelediamine and tetraethylenepentamine are exemplified. As secondary aliphatic amines, for example, dimethylamine, diethylamine, di-n-propylamine, diisopropylamine, di-n-butylamine, diisobutylamine, di-sec-butylamine, dipentylamine, dicyclopentylamine, dihexylamine, dicyclohexylamine, diheptylamine, dioctylamine, dinonylamine, didecylamine, didodecylamine, dicetylamine, N,N-dimethylmethylenediamine, N,N-dimethylethylenediamine, and N,N-dimethyltetraethylenepentamine are exemplified. As tertiary aliphatic amines, for example, trimethylamine, triethylamine, tri-n-propylamine, triisopropylamine, tri-n-butylamine, triisobutylamine, tri-sec-butylamine, tripentylamine, tricyclopentylamine, trihexylamine, tricyclohexylamine, triheptylamine, trioctylamine, trinonylamine, tridecylamine, tridodecylamine, tricetylamine, N,N,N′,N′-tetramethylmethylenediamine, N,N,N′,N′-tetramethylethylenediamine, and N,N,N′,N′-tetramethyltetraethylenepentamine are exemplified.

As mixed amines, for example, dimethylethylamine, methylethylpropylamine, benzylamine, phenetylamine and benzyldimethylamine are exemplified. As specific examples of aromatic amines and heterocyclic amines, for example, aniline derivatives (e.g., aniline, N-methylaniline, N-ethylaniline, N-propylaniline, N,N-dimethylaniline, 2-methylaniline, 3-methylaniline, 4-methylaniline, ethylaniline, propylaniline, trimethylaniline, 2-nitroaniline, 3-nitroaniline, 4-nitroaniline, 2,4-dinitroaniline, 2,6-dinitroaniline, 3,5-dinitroaniline, and N,N-dimethyltoluidine), diphenyl(p-tolyl)amine, methyldiphenylamine, triphenylamine, phenylenediamine, naphthylamine, diaminonaphthalene, pyrrole derivatives (e.g., pyrrole, 2H-pyrrole, 1-methylpyrrole, 2,4-dimethylpyrrole, 2,5-dimethylpyrrole, and N-methylpyrrole), oxazole derivatives (e.g., oxazole and isoxazole), thiazole derivatives (e.g., thiazole and isothiazole), imidazole derivatives (e.g., imidazole, 4-methylimidazole, and 4-methyl-2-phenylimidazole), pyrazole derivatives, furazane derivatives, pyrroline derivatives (e.g., pyrroline and 2-methyl-1-pyrroline), pyrrolidine derivatives (e.g., pyrrolidine, N-methylpyrrolidine, pyrrolidinone and N-methylpyrrolidone), imidazoline derivatives, imidazolidine derivatives, pyridine derivatives (e.g., pyridine, methylpyridine, ethylpyridine, propylpyridine, butylpyridine, 4-(1-butylpentyl)pyridine, dimethylpyridine, trimethylpyridine, triethylpyridine, phenylpyridine, 3-methyl-2-phenylpyridine, 4-tert-butylpyridine, diphenylpyridine, benzylpyridine, methoxypyridine, butoxypyridine, dimethoxypyridine, 4-pyrolidinopyridine, 2-(1-ethylpropyl)pyridine, aminopyridine, and dimethylaminopyridine), pyridazine derivatives, pyrimidine derivatives, pyrazine derivatives, pyrazoline derivatives, pyrazolidine derivatives, piperidine derivatives, piperazine derivatives, morpholine derivatives, indole derivatives, isoindole derivatives, 1H-indazole derivatives, indoline derivatives, quinoline derivatives (e.g., quinoline, and 3-quinolinecarbonitrile), isoquinoline derivatives, cinnoline derivatives, quinazoline derivatives, quinoxaline derivatives, phthalazine derivatives, purine derivatives, pteridine derivatives, carbazole derivatives, phenanthridine derivatives, acridine derivatives, phenazine derivatives, 1,10-phenanthroline derivatives, adenine derivatives, adenosine derivatives, guanine derivatives, guanosine derivatives, uracil derivatives, and uridine derivatives are exemplified.

Furthermore, as the nitrogen-containing compounds having the carboxy group, for example, such as aminobenzoic acid, indolecarboxylic acid, amino acid derivatives (e.g., nicotinic acid, alanine, arginine, aspartic acid, glutamic acid, glycine, histidine, isoleucine, glycylleucine, leucine, methionine, phenylalanine, threonine, lysine, 3-aminopyrazine-2-carboxylic acid, and methoxyalanine) are exemplified. As the nitrogen-containing compounds having the sulfonyl group,for example, such as 3-pyridinesulfonic acid and pyridinium p-toluenesulfonate are exemplified. As the nitrogen-containing compounds having the hydroxyl group, the nitrogen-containing compounds having hydroxyphenyl group, the alcoholic nitrogen-containing compounds, for example, such as 2-hydroxypyridine, aminocresol, 2,4-quinolinediol, 3-indolmethanol hydrate, monoethanolamine, diethanolamine, triethanolamine, N-ethyl diethanolamine, N,N-diethyl ethanolamine, triisopropanolamine, 2,2′-iminodiethanol, 2-aminoethanol, 3-amino-1-propanol, 4-amino-1-butanol, 4-(2-hydroxyethyl)morpholine, 2-(2-hydroxyethyl)pyridine, 1-(2-hydroxyethyl)piperazine, 1-[2-(2-hydroxyethoxy)ethyl]piperazine, piperidine ethanol, 1-(2-hydroxyethyl)pyrrolidine, 1-(2-hydroxyethyl)-2-pyrrolidinone, 3-piperidino-1,2-propanediol, 3-pyrrolidino-1,2-propanediol, 8-hydroxyurolidine, 3-quinuclidiol, 3-tropanol, 1-methyl-2-pyrrolidine ethanol, 1-aziridine ethanol, N-(2-hydroxyethyl)phthalimide, and N-(2-hydroxyethyl)isonicotinamide are exemplified. As amides, for example, such as formamide, N-methylformamide, N,N-dimethylformamide, acetamide, N-methylacetamide, N,N-dimethylacetamide, propionamide, benzamide, and 1-cyclohexylpyrrolidone are exemplified. As imides, for example, such as phthalimide, succinimide and maleimide are exemplified. As carbamates, for example, such as N-t-butoxycarbonyl-N,N-dicyclohexylamine, N-t-butoxycarbonyl benzimidazole and oxazolidinone are exemplified.

Further, the nitrogen-containing organic base represented by the following general formula (C)-1 is exemplified:

N(X)ₙ(Y)₃₋ₙ (C)-1

wherein n=1, 2 or 3; side chains X may be the same or different, and can be represented by the following general formulae (X1) to (X3); side chains Y may be the same or different, denote hydrogen atoms or linear, branched or cyclic alkyl groups having 1-20 carbon atoms, and may comprise ether or hydroxy. The side chains X may be bound one another to form a ring.

—R2-O—R3 (X1)

—R4-O—R5-CO—R6 (X2)

—R7-COO—R8 (X3)

In the above general formulae (X1) to (X3), R2, R4 and R7 represent linear or branched alkylene groups having 1-4 carbon atoms, R3 and R6 represent hydrogen atoms, or linear, branched or cyclic alkyl groups having 1-20 carbon atoms and may comprise one or more of a hydroxyl group, an ether group, an ester group and a lactone ring.

R5 represents a single bond or a linear or branched alkylene group having 1-4 carbon atoms, and R8 represents a linear, branched or cyclic alkyl group having 1-20 carbon atoms and may comprise one or more of a hydroxyl group, an ether group, an ester group and a lactone ring.

As the compound represented by the general formula (C)-1, specifically, tris(2-methoxymethoxyethl)amine, tris{2-(2-methoxyethoxy)ethyl}amine, tris{2-(2-methoxyethoxymethoxy)ethyl}amine, tris{2-(1-methoxyethoxy)ethyl}amine, tris{2-(1-ethoxyethoxy)ethyl}amine, tris{2-(1-ethoxypropoxy)ethyl}amine, tris[2-{2-(2-hydroxyethoxy)ethoxy}ethyl]amine, 4,7,13,16,21,24-hexaoxa-1,10-diazabicyclo[8.8.8]hexacosane, 4,7,13,18-tetraoxa-1,10-diazabicyclo[8.5.5]eicosane, 1,4,10,13-tetraoxa-7,16-diazabicyclooctadecane, 1-aza-12-crown-4,1-aza-15-crown-5,1-aza-18-crown-6, tris(2-formyloxyethyl)amine, tris(2-acetoxyethyl)amine, tris(2-propionyloxyethyl)amine, tris(2-butylyloxyethyl)amine, tris(2-isobutylyloxyethyl)amine, tris(2-valelyloxyethyl)amine, tris(2-pivaloyloxyethyl)amine, N,N-bis(2-acetoxyethyl)-2-(acetoxyacetoxy)ethylamine, tris(2-methoxycarbonyloxyethyl)amine, tris(2-tert-butoxycarbonyloxyethyl)amine, tris[2-(2-oxopropoxy)ethyl]amine, tris[2-(methoxycarbonylmethyl)oxyethyl]amine, tris[2-(tert-butoxycarbonylmethyloxy)ethyl]amine, tris[2-(cyclohexyloxycarbonylmethyoxy)ethyl]amine, tris(2-methoxycarbonylethyl)amine, tris(2-ethoxycarbonylethyl)amine, N,N-bis(2-hydroxyethyl)-2-(methoxycarbonyl)ethylamine, N,N-bis(2-acetoxyethyl)-2-(methoxycarbonyl)ethylamine, N,N-bis(2-hydroxyethyl)-2-(ethoxycarbonyl)ethylamine, N,N-bis(2-acetoxyethyl)-2-(ethoxycarbonyl)ethylamine, N,N-bis(2-hydroxyethyl)-2-(2-methoxyethoxycarbonyl)ethylamine, N,N-bis(2-acetoxyethyl)-2-(2-methoxyethoxycarbonyl)ethylamine, N,N-bis(2-hydroxyethyl)-2-(2-hydroxyethoxycarbonyl)ethylamine, N,N-bis(2-acetoxyethyl)-2-(2-acetoxyethoxycarbonyl)ethylamine, N,N-bis(2-hydroxyethyl)-2-[(methoxycarbonyl)methoxycarbonyl]ethylamine, N,N-bis(2-acetoxyethyl)-2-[(methoxycarbonyl)methoxycarbonyl]ethylamine, N,N-bis(2-hydroxyethyl)-2-(2-oxopropoxycarbonyl)ethylamine, N,N-bis(2-acetoxyethyl)-2-(2-oxopropoxycarbonyl)ethylamine, N,N-bis(2-hydroxyethyl)-2-(2-tetrahydrofurfuryloxycarbonyl)ethylamine, N,N-bis(2-acetoxyethyl)-2-(2-tetrahydrofurfuryloxycarbonyl)ethylamine, N,N-bis(2-hydroxyethyl)-2-[(2-oxotetrahydrofuran-3-yl)oxycarbonyl]ethylamine, N,N-bis(2-acetoxyethyl)-2-[(2-oxotetrahydrofuran-3-yl)oxycarbonyl]ethylamine, N,N-bis(2-hydroxyethyl)-2-(4-hydroxybutoxycarbonyl)ethylamine, N,N-bis(2-formyloxyethyl)-2-(4-formyloxybutoxycarbonyl)ethylamine, N,N-bis(2-formyloxyethyl)-2-(4-formyloxyethoxycarbonyl)ethylamine, N,N-bis(2-methoxyethyl)-2-(methoxycarbonyl)ethylamine, N-(2-hydroxyethyl)bis[2-(methoxycarbonyl)ethyl]amine, N-(2-acetoxyethyl)bis[2-(methoxycarbonyl)ethyl]amine, N-(2-hydroxyethyl)bis[2-(ethoxycarbonyl)ethyl]amine, N-(2-acetoxyethyl)bis[2-(ethoxycarbonyl)ethyl]amine, N-(3-hydroxy-1-propyl)bis[2-(methoxycarbonyl)ethyl]amine, N-(3-acetoxy-1-propyl)bis[2-(methoxycarbonyl)ethyl]amine, N-(2-methoxyethyl)bis[2-(methoxycarbonyl)ethyl]amine, N-butylbis[2-(methoxycarbonyl)ethyl]amine, N-butylbis[2-(2-methoxyethoxycarbonyl)ethyl]amine, N-methylbis(2-acetoxyethyl)amine, N-ethylbis(2-acetoxyethyl)amine, N-methylbis(2-pivaloyloxyethyl)amine, N-ethylbis[2-(methoxycarbonyloxy)ethyl]amine, N-ethylbis[2-(tert-butoxycarbonyloxy)ethyl]amine, tris(methoxycarbonylmethyl)amine, tris(ethoxycarbonylmethyl)amine, N-butylbis(methoxycarbonylmethyl)amine, N-hexylbis(methoxycarbonylmethyl)amine, and β-(diethylamino)-δ-valerolactone are exemplified.

Further, the nitrogen-containing organic base having a cyclic structure represented by the following general formula (C)-2 is exemplified.

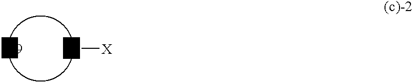

In the formula, X is the same as defined above, and R9 represents a linear or branched alkylene group having 2-20 carbon atoms and may comprise one or more of a carbonyl group, an ether group, an ester group and a sulfide group.

As the compounds represented by the formula (C)-2, specifically, 1-[2-(methoxymethoxy)ethyl]pyrrolidine, 1-[2-(methoxymethoxy)ethyl]piperidine, 4-[2-(methoxymethoxy)ethyl]morpholine, 1-[2-[(2-methoxyethoxy)methoxy]ethyl]pyrrolidine, 1-[2-[(2-methoxyethoxy)methoxy]ethyl]piperidine, 4-[2-[(2-methoxyethoxy)methoxy]ethyl]morpholine, 2-(1-pyrrolidinyl)ethyl acetate, 2-piperidinoethyl acetate, 2-morpholinoethyl acetate, 2-(1-pyrrolidinyl)ethyl formate, 2-piperidinoethyl propionate, 2-morpholinoethyl acetoxyacetate, 2-(1-pyrrolidinyl)ethyl methoxyacetate, 4-[2-(methoxycarbonyloxy)ethyl]morpholine, 1-[2-(t-butoxycarbonyloxy)ethyl]piperidine, 4-[2-(2-methoxyethoxycarbonyloxy)ethyl]morpholine, methyl 3-(1-pyrrolidinyl)propionate, methyl 3-piperidinopropionate, methyl 3-morpholinopropionate, methyl 3-(thiomorpholino)propionate, methyl 2-methyl-3-(1-pyrrolidinyl)propionate, ethyl 3-morpholinopropionate, methoxycarbonylmethyl 3-piperidinopropionate, 2-hydroxyethyl 3-(1-pyrrolidinyl)propionate, 2-acetoxyethyl 3-morpholinopropionate, 2-oxotetrahydrofuran-3-yl 3-(1-pyrrolidinyl)propionate, tetrahydrofurfuryl 3-morpholinopropionate, glycidyl 3-piperidinopropionate, 2-methoxyethyl 3-morpholinopropionate, 2-(2-methoxyethoxy)ethyl 3-(1-pyrrolidinyl)propionate, butyl 3-morpholinopropionate, cyclohexyl 3-piperidinopropionate, α-(1-pyrrolidinyl)methyl-γ-butylolactone, β-piperidino-γ-butylolactone, β-morpholino-δ-valerolactone, methyl 1-pyrrolidinylacetate, methyl piperidinoacetate, methyl morpholinoacetate, methyl thiomorpholinoacetate, ethyl 1-pyrrolidinylacetate, 2-methoxyethyl morpholinoacetate, 2-morpholinoethyl 2-methoxyacetate, 2-morpholinoethyl 2-(2-methoxyethoxy)acetate, 2-morpholinoethyl 2-[2-(2-methoxyethoxy)ethoxy]acetate, 2-morpholinoethyl hexanoate, 2-morpholinoethyl octanoate, 2-morpholinoethyl decanoate, 2-morpholinoethyl laurate, 2-morpholinoethyl myristate, 2-morpholinoethyl palmitate and 2-morpholinoethyl stearate are exemplified.

Further, the nitrogen-containing organic bases comprising a cyano group(s) represented by the general formulae (C)-3 to (C)-6 are exemplified.

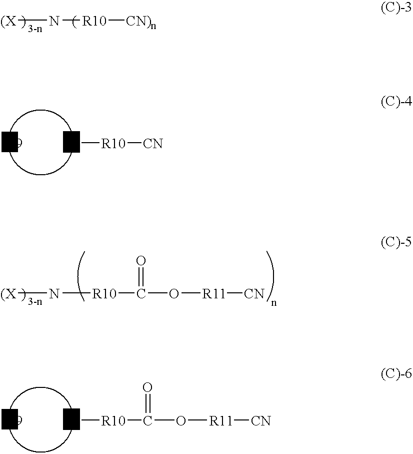

In the formulae, X, R9 and n are the same as defined above, and R10 and R11 may be the same or different and represent linear or branched alkylene groups having 1-4 carbon atoms.

As the nitrogen-containing organic base comprising the cyano group(s) represented by the general formulae (C)-3 to (C)-6, specifically, 3-(diethylamino)propiononitrile, N,N-bis(2-hydroxyethyl)-3-aminopropiononitrile, N,N-bis(2-acetoxyethyl)-3-aminopropiononitrile, N,N-bis(2-formyloxyethyl)-3-aminopropiononitrile, N,N-bis(2-methoxyethyl)-3-aminopropiononitrile, N,N-bis[2-(methoxymethoxy)ethyl]-3-aminopropiononitrile, methyl N-(2-cyanoethyl)-N-(2-methoxyethyl)-3-aminopropionate, methyl N-(2-cyanoethyl)-N-(2-hydroxyethyl)-3-aminopropionate, methyl N-(2-acetoxyethyl)-N-(2-cyanoethyl)-3-aminopropionate, N-(2-cyanoethyl)-N-ethyl-3-aminopropiononitrile, N-(2-cyanoethyl)-N-(2-hydroxyethyl)-3-aminopropiononitrile, N-(2-acetoxyethyl)-N-(2-cyanoethyl)-3-aminopropiononitrile, N-(2-cyanoethyl)-N-(2-formyloxyethyl)-3-aminopropiononitrile, N-(2-cyanoethyl)-N-(2-methoxyethyl)-3-aminopropiononitrile, N-(2-cyanoethyl)-N-[2-(methoxymethoxy)ethyl]-3-aminopropiononitrile, N-(2-cyanoethyl)-N-(3-hydroxy-1-propyl)-3-aminopropiononitrile, N-(3-acetoxy-1-propyl)-N-(2-cyanoethyl)-3-aminopropiononitrile, N-(2-cyanoethyl)-N-(3-formyloxy-1-propyl)-3-aminopropiononitrile, N-(2-cyanoethyl)-N-tetrahydrofurfuryl-3-aminopropiononitrile, N,N-bis(2-cyanoethyl)-3-aminopropiononitrile, diethylaminoacetonitrile, N,N-bis(2-hydroxyethyl)aminoacetonitrile, N,N-bis(2-acetoxyethyl)aminoacetonitrile, N,N-bis(2-formyloxyethyl)aminoacetonitrile, N,N-bis(2-methoxyethyl)aminoacetonitrile, N,N-bis[2-(methoxymethoxy)ethyl]aminoacetonitrile, methyl N-cyanomethyl-N-(2-methoxyethyl)-3-aminopropionate, methyl N-cyanomethyl-N-(2-hydroxyethyl)-3-aminopropionate, methyl N-(2-acetoxyethyl)-N-cyanomethyl-3-aminopropionate, N-cyanomethyl-N-(2-hydroxyethyl)aminoacetonitrile, N-(2-acetoxyethyl)-N-(cyanomethyl)aminoacetonitrile, N-cyanomethyl-N-(2-formyloxyethyl)aminoacetonitrile, N-cyanomethyl-N-(2-methoxyethyl)aminoacetonitrile, N-cyanomethyl-N-[2-(methoxymethoxy)ethyl]aminoacetonitrile, N-cyanomethyl-N-(3-hydroxy-1-propyl)aminoacetonitrile, N-(3-acetoxy-1-propyl)-N-(cyanomethyl)aminoacetonitrile, N-cyanomethyl-N-(3-formyloxy-1-propyl)aminoacetonitrile, N,N-bis(cyanomethyl)aminoacetonitrile, 1-pyrrolidinepropiononitrile, 1-piperidinepropiononitrile, 4-morpholinepropiononitrile, 1-pyrrolidineacetonitrile, 1-piperidineacetonitrile, 4-morpholineacetonitrile, cyanomethyl 3-diethylaminopropionate, cyanomethyl N,N-bis(2-hydroxyethyl)-3-aminopropionate, cyanomethyl N,N-bis(2-acetoxyethyl)-3-aminopropionate, cyanomethyl N,N-bis(2-formyloxyethyl)-3-aminopropionate, cyanomethyl N,N-bis(2-methoxyethyl)-3-aminopropionate, cyanomethyl N,N-bis[2-(methoxymethoxy)ethyl]-3-aminopropionate, (2-cyanoethyl) 3-diethylaminopropionate, (2-cyanoethyl) N,N-bis(2-hydroxyethyl)-3-aminopropionate, (2-cyanoethyl) N,N-bis(2-acetoxyethyl)-3-aminopropionate, (2-cyanoethyl) N,N-bis(2-formyloxyethyl)-3-aminopropionate, (2-cyanoethyl) N,N-bis(2-methoxyethyl)-3-aminopropionate, (2-cyanoethyl) N,N-bis[2-(methoxymethoxy)ethyl]-3-aminopropionate, cyanomethyl 1-pyrrolidinepropionate, cyanomethyl 1-piperidinepropionate, cyanomethyl 4-morpholinepropionate, (2-cyanoethyl) 1-pyrrolidinepropionate, (2-cyanoethyl) 1-piperidinepropionate, and (2-cyanoethyl) 4-morpholinepropionate are exemplified.

Further, the nitrogen-containing organic base having an imidazole skeleton and a polar functional group represented by the following general formula (C)-7 are exemplified.

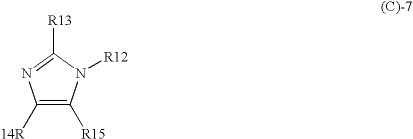

In the formula, R12 represents a linear, branched or cyclic alkyl group having 2-20 carbon atoms and the polar functional group and comprises one or more of a hydroxyl group, a carbonyl group, an ester group, an ether group, a sulfide group, a carbonate group, a cyano group and an acetal group as the polar functional group(s); and R13, R14 and R15 represent hydrogen atoms, linear, branched or cyclic alkyl, aryl or aralkyl groups having 1-10 carbon atoms.

Further, the nitrogen-containing organic base having a benzimidazole skeleton and a polar functional group represented by the following general formula (C)-8 are exemplified.

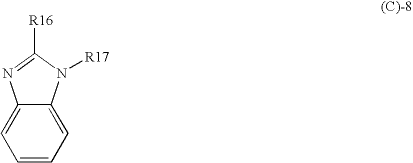

In the formula, R16 represents a hydrogen atom, or a linear, branched or cyclic alkyl, aryl or aralkyl group having 1 to 10 carbon atoms; and R17 represents a linear, branched or cyclic alkyl group having 1-20 carbon atoms and having the polar functional group(S), and comprises one or more of an ester group, an acetal group and a cyano group and additionally may comprise one or more of a carbonyl group, an ether group, a sulfide group and a carbonate group.

Further, the nitrogen-containing heterocyclic compounds having polar functional groups represented by the following general formulae (C)-9 and (C)-10 are exemplified.

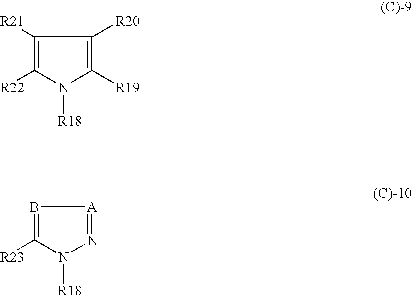

In the formulae, A represents a nitrogen atom or ≡C—R24; B represents a nitrogen atom or ≡C—R25; R18 represents a linear, branched or cyclic alkyl group having 2-20 carbon atoms and having the polar functional group(s) and comprises one or more of a carbonyl group, an ester group, an ether group, a sulfide group, a carbonate group, a cyano group or an acetal group as the polar functional group(s); R19, R20, R21 and R22 represent hydrogen atoms, linear, branched or cyclic alkyl or aryl groups having 1-10 carbon atoms, or R19 and R20, and R21 and R22 may be bound one another to form benzene, naphthalene or pyridine rings; R23 represents a hydrogen atom, a linear, branched or cyclic alkyl or aryl group having 1-10 carbon atoms; and R24 and R25 represent hydrogen atoms, linear, branched or cyclic alkyl or aryl groups having 1-10 carbon atoms, or may be bound one another to form a benzene or naphthalene ring.

Further, the nitrogen-containing organic bases having a aromatic carboxylate ester structure represented by the following general formulae (C)-11, 12, 13 and 14 are exemplified.

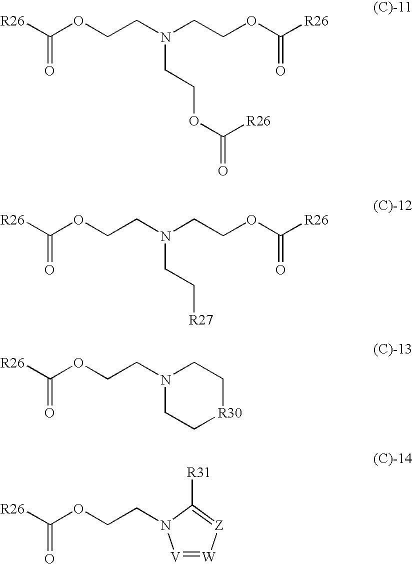

In the formulae, R26 represents an aryl group having 6-20 carbon atoms or a hetero aromatic group having 4 to 20 carbon atoms, wherein a part of or all hydrogen atoms may be optionally substituted with a halogen atom, a linear, branched or cyclic alkyl group having 1-20 carbon atoms, an aryl group having 6-20 carbon atoms, an aralkyl group having 7-20 carbon atoms, an alkoxy group having 1-10 carbon atoms, an acyloxy group having 1-10 carbon atoms or an alkylthio group having 1-10 carbon atoms; R27 represents CO₂R28, OR29 or cyano group; R28 represents an alkyl group having 1-10 carbon atoms wherein a part of methylene groups may be substituted with oxygen atoms; R29 represents an alkyl group or an acyl group having 1-10 carbon atoms wherein a part of methylene groups may be optionally substituted with an oxygen atom; R30 represents a single bond, a methylene group, an ethylene group, a sulfur atom or —O(CH₂CH₂O)ₙ— (n represents an integer of 0, 1, 2, 3 or 4); R31 represents a hydrogen atom, a methyl group, an ethyl group or a phenyl group; V represents a nitrogen atom or CR32; W represents a nitrogen atom or CR33; Z represents a nitrogen atom or CR34; R32, R33 and R34 each independently represent a hydrogen atom, a methyl group or a phenyl group, or R32 and R33 or R33 and R34 may be bound one another to form an aromatic ring having 6-20 carbon atoms or a hetero aromatic ring having 2-20 carbon atoms.

Further, the nitrogen-containing organic base having a 7-oxanorbornane-2-carboxylate ester structure represented by the following general formula (C)-15 is exemplified.

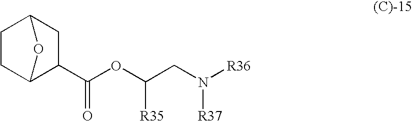

In the formula, R35 represents a hydrogen atom or a linear, branched or cyclic alkyl group having 1-10 carbon atoms; R36 and R37 each independently represent alkyl group having 1-20 carbon atoms, an aryl group having 6-20 carbon atoms or an aralkyl group having 7-20 carbon atoms, which may comprise one or more of polar functional groups such as ether, carbonyl, ester, alcohol, thio, nitrile, amine, imine and amide and where a part of hydrogen atoms may be substituted with a halogen atom; and R36 and R37 may be bound one another to form a hetero ring or a hetero aromatic ring having 2-20 carbon atoms.

The nitrogen-containing organic base added to the monomolecular film forming material is preferably the nitrogen-containing organic base containing the following structural formula (1) among the above nitrogen-containing organic bases:

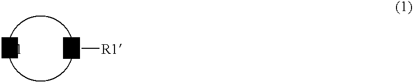

wherein R1 represents a linear, cyclic or branched alkylene group having 2-20 carbon atoms and may comprise one or more of a carbonyl group, an ether group, an ester group, and a sulfide group; and R1′ represents hydrogen or a linear or branched alkyl group having 1-25 carbon atoms and may comprise one or more of a carbonyl group, an ether group, an ester group and a lactone ring.

For the condensation of the silane compound, it is known that its condensation can be facilitated by particularly making its aqueous solution basic. However, the action of the base in the organic solvent is not known well. According to the investigation in the present invention, it has been found that the monomolecular film is formed more easily if the nitrogen-containing organic base having the above cyclic structure is used.

According to the further investigation, it has been found that the monomolecular film is formed still more easily if a pyrrolidine derivative or a piperidine derivative is used as the nitrogen-containing organic base.

That is, the nitrogen-containing organic base added to the monomolecular film forming material is more preferably the pyrrolidine derivative or the piperidine derivative, and still more preferably pyrrolidine, N-methylpyrrolidine, piperidine and N-methylpiperidine are exemplified. However, the nitrogen-containing organic base is not limited thereto.

Examples of the solvents used when the monomolecular film is formed according to the present invention include ketones such as cyclohexanone and methyl-2-n-amyl ketone, alcohols such as 3-methoxybutanol, 3-methyl-3-methoxybutanol, 1-methoxy-2-propanol and 1-ethoxy-2-propanol, ethers such as propylene glycol monomethyl ether, ethylene glycol monomethyl ether, propylene glycol monoethyl ether, ethylene glycol monoethyl ether, propylene glycol dimethyl ether and diethylene glycol dimethyl ether, esters such as propylene glycol monomethyl ether acetate, propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate and propylene glycol mono-tert-butyl ether acetate, lactones such as γ-butylolactone, hydrocarbons such as n-hexane and n-nonane, and aromatics such as benzene, toluene and chloroform. These solvents may be used alone or in mixture of two or more, but the solvent is not limited thereto.

It can be easily supposed that the material for recognition is more easily immobilized when the space around the hydroxyl group which is the functional group for immobilizing the material for recognition is not dense. In order to make such a condition, it is preferable to mix and use the silane compound represented by the above general formula (A) together with the silane compound represented by the following general formula (B):

Y′₃Si—(CH₂)ₙ—CH₃ (B)

wherein n represents an integer of 0 or more (m-2) (m is the value in the above general formula (A); and Y′ each independently represent halogen atoms or alkoxy groups having 1-4 carbon atoms, having an alkyl chain being slightly short in chain length. It is also preferable to use the compound represented by the compound (B) in the amount at one time mole or more and more preferably 4 times mole or more relative to the amount of the silane compound represented by the general formula (A). To assure the amount to be immobilized, the amount of the compound (B) is preferably 50 times mole or less and more preferably 20 times mole or less.

To form the monomolecular film having the silicon oxide chain derived from the above silane compound, for example, the solvent having the very low polarity is used, a solution of the silane compound represented by the above general formula (A) or the mixture thereof with the compound represented by the general formula (B) is made at 2.0×10⁻² to 5.0×10⁻² mole/L which is relatively dilute, further the nitrogen-containing organic base is adjusted to 2.0×10⁻² to 5.0×10⁻² mole/L, and the coated substrate where the region not to be coated may have been protected with the resist is immersed therein for about 24 hours in the case of using the trichlorosilane compound.

In the present invention, for a concentration ratio of the silane compound to the nitrogen-containing organic base, it is preferable to make a molar ratio of the nitrogen-containing organic base to be 0.1 to 100 relative to 1 of the silane compound for easily forming the monomolecular film.

By deprotecting the hydroxyl group precursor X′ after the above-mentioned treatments, the substrate for making the microarray, coated with the monomolecular film having the silicon oxide chain having the hydroxyl group as the functional group to immobilize is obtained. In the above deprotection, the ordinary deprotection method for the protecting group used could be used, and for example, oxyranyl and acetal can be made into hydroxy by treating with an oxygen atmosphere containing water.

The substrate for making the microarray is completed by removing the resist pattern with the organic solvent capable of dissolving the resist film, e.g., the solvent such as propylene glycol monomethyl ether or ethyl lactate generally used when the resist solution is prepared, after the above-mentioned treatments. In the substrate obtained above, the hydroxyl groups having the polarity are present abundantly on the surface, and thus, even when the positive type resist is applied directly, the adhesiveness to the resist film can be assured. If necessary, the terminal hydroxyl group can be converted into formyl group by the use of periodic acid, and it is also possible to change the immobilization method.

### EXAMPLES

The present invention will be described further in detail with reference to Examples and Comparative Examples. However, the present invention is not limited by the following Examples.

### Production Example 1

### Production of 10-(methoxymethoxy)decyltrimethoxysilane

Under a nitrogen atmosphere, 64 g of trimethoxysilane and 0.57 g of acetic acid were dropped in a mixture of 100 g of 10-(methoxymethoxy)-1-decene and a catalytic amount of a solution of platinate chloride in tetrahydrofuran at 80° C. The reaction mixture was stirred at 80° C. for 3 hours, and distilled under reduced pressure to yield 131 g of an target compound.

10-(methoxymethoxy)decyltrimethoxysilane

Boiling point: 142° C./66 Pa

1R (liquid film) vmax: 2927, 2854, 2840, 1465, 1191, 1143, 1089, 1049 cm⁻¹.

¹³C-NMR (150 MHz, CDCl₃) δ: 9.10, 22.55, 26.18, 29.19, 29.39, 29.56, 29.71, 33.09, 50.44, 55.03, 67.84, 96.34 ppm.

¹H-NMR (600 MHz, CDCl₃) δ: 0.59-0.62 (2H, m), 1.21-1.39 (14H, m), 1.52-1.57 (2H, quintet-like), 3.32 (3H, s), 3.48 (2H, t, J=7 Hz), 3.53 (9H, s), 4.58 (2H, s) ppm.

### Production Example 2

Production of polymer for resist t-Butoxystyrene: 1-ethylcyclopentyl methacrylate: β-methacryloyloxy-γ-butylolactone=30:10:60

17.6 g of t-Butoxystyrene, 18.2 g of 1-ethylcyclopentyl methacrylate and 17.0 g of β-methacryloyloxy-γ-butylolactone were dissolved in 1100 g of methyl isobutyl ketone, and 1.3 g of AIBN was added, and then the mixture was heated at 80° C. for 8 hours. This was poured in a large amount if hexane to precipitate, further the precipitate was dissolved in a small amount of methyl isobutyl ketone, and reprecipitation was performed in a large amount of hexane. This manipulation yielded a copolymer having a molecular weight of about 8,000 and a dispersion degree of 2.0 and the above-mentioned composition.

### Production Example 3

### Preparation of Resist Composition

Polymethyl methacrylate (80 parts by mass) was dissolved in 720 parts by mass of water, which was then filtrated through a filter to make a resist composition.

### Production Example 4

### Preparation of Monomolecular Film Forming Material Solution

10-(Methoxymethoxy)decyltrimethoxysilane obtained in Production Example 1 was prepared to be 0.02 mole % in a mixed solvent of 4% dichloromethane/hexane.

An addition compound was added to the resulting solution according to the following composition to prepare monomolecular film forming material solutions 1 to 8 (reaction solutions 1 to 8).

TABLE 1

| | | Prepared | |
|---|---|---|---|
| | Addition compound | concentration | |
| Reaction solution 1 | Triethylamine | 5 | mole % |
| Reaction solution 2 | Diisopropylamine | 0.02 | mole % |
| Reaction solution 3 | Cyclohexylamine | 0.02 | mole % |
| Reaction solution 4 | Piperidine | 0.02 | mole % |
| Reaction solution 5 | Pyrrolidine | 5 | mole % |
| Reaction solution 6 | Pyrrolidine | 0.02 | mole % |
| Reaction solution 7 | Pyrrolidine | 0.0005 | mole % |
| Reaction solution 8 | n-Dibutyl tin diacetate | 0.0005 | mole % |

(Production of Substrate for Making Microarray)

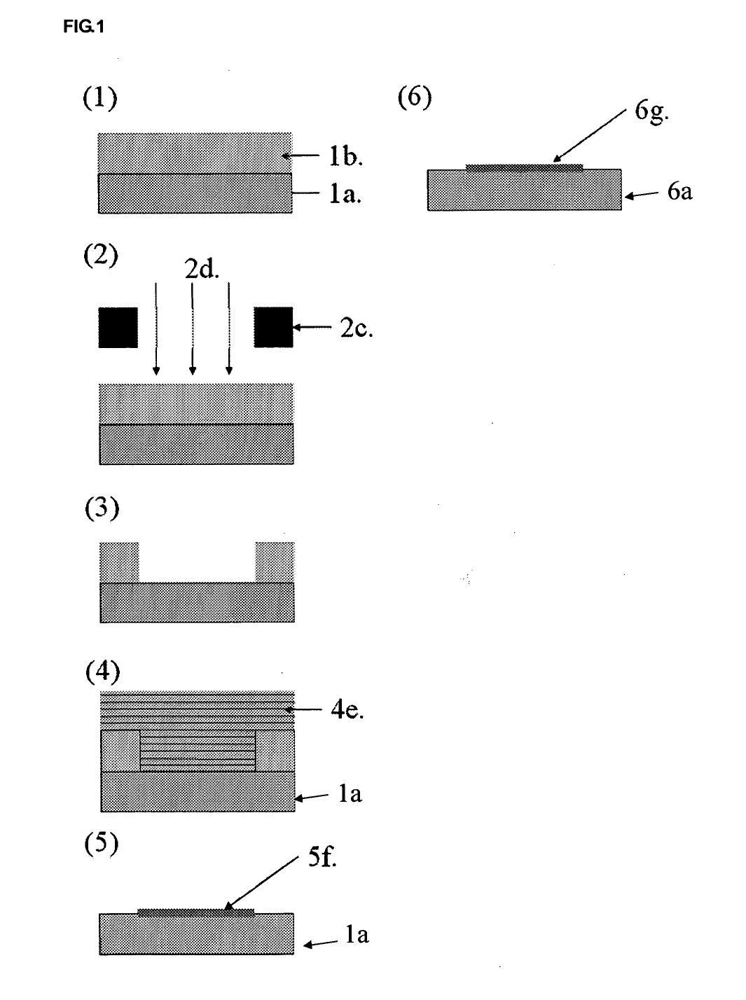

The solution of the resist composition prepared in the above Production Example 3 was spin-coated on a substrate 1a to be processed, to which pre-baking at 100° C. for 10 minutes was then given to yield a resist film 1b having a film thickness of 0.5 μm (FIG. 1(1)).

Subsequently, electron beam 2d was irradiated on a region on which a monomolecular film would be formed using a mask pattern 2c on this resist film 1b (FIG. 1(2)). After the exposure, a resist pattern having an opening at the region where the monomolecular film would be formed was obtained by developing in a mixed solution of methyl isobutyl ketone and isopropyl alcohol (FIG. 1(3)).

Subsequently, the above substrate 1a was immersed in the reaction solution 3 (monomolecular film forming material solution 4e) obtained in Production Example 4 for 12 hours to form a monomolecular film 5f (FIG. 1(5)). The substrate is immersed in chloroform, subsequently acetone and then water for each 5 minutes with sonication to wash the substrate, and simultaneously remove the resist film 1b.

Subsequently, the substrate 1a given the above-mentioned treatment was treated with a methanol solution prepared so that concentrated hydrochloric acid was at a concentration of 0.8% by mass at 60° C. for 30 minutes to deprotect methoxymethoxy group in the monomolecular film 5f to make hydroxyl group.

This gave the substrate 6a for making the microarray, on which the monomolecular film 6g having the silicon oxide chain having the hydroxyl group as the functional group for the immobilization at the position at which the recognition material would be immobilized had been formed (FIG. 1(6)).

(Measurement of Contact Angle and Detachment Evaluation of Monomolecular Film)

A wafer having the surface of a silicon oxide film was immersed in each reaction solution obtained in Production Example 4 for 2, 6, 12, 24, or 48 hours, respectively to form the monomolecular film. The substrate was immersed in chloroform and subsequently acetone for each 5 minutes to perform ultrasonic washing. Then, a contact angle with water on the surface of the monomolecular film was measured.

Obtained results are shown in the following Table 2.

TABLE 2

| | Reaction | Contact angle (degree) | | | | |
|---|---|---|---|---|---|---|
| | solution | 2 hrs | 6 hrs | 12 hrs | 24 hrs | 48 hrs |
| Example 1 | 1 | 45 | 60 | 65 | 70 | 75 |
| Example 2 | 2 | 50 | 63 | 70 | 75 | 75 |
| Example 3 | 3 | 50 | 63 | 70 | 75 | 75 |
| Example 4 | 4 | 55 | 70 | 75 | 75 | 75 |
| Example 5 | 5 | 50 | 63 | 70 | 75 | 75 |
| Example 6 | 6 | 55 | 70 | 75 | 75 | 75 |
| Example 7 | 7 | 50 | 62 | 68 | 75 | 75 |
| Comparative | 8 | 73 | 75 | 75 | 75 | 75 |
| Example 1 | | | | | | |

From the results in Table 2, a speed of forming the film for the monomolecular film was the fastest in Examples 4 and 6, the second fastest in Examples 2, 3 and 5 similarly, followed by Examples 7 and 1. That is, it could be identified that the speed of forming the film could be fast by using pyrrolidine or piperidine containing the cyclic structure of the above structural formula (1) as the nitrogen-containing organic base (Examples 4 to 6). Furthermore, comparing the concentration ratios of the nitrogen-containing organic base to the silane compound in the cases of the molar ratio 250 (Example 5), 1 (Example 6) and 0.025 (Example 7) of the nitrogen-containing organic base relative to 1 of the silane compound, it could be identified that the speed of forming the film was the fastest in Example 6 having the molar ratio of 1.

The film thickness of the monomolecular film on the wafer after 48 hours was obtained by ellipsometry, and consequently was 2.1 nm in all cases.

Subsequently, supposing the cases where the process manipulations such as post-modifying the alkyl chain extending from the silicon atom in the monomolecular film with an enzyme, DNA or alkyl group were performed, the detachment of the monomolecular film was evaluated.

That is, each wafer in the above was heated in methanol at 60° C. for 20 minutes (manipulation 1), subsequently, heated in a methanol solution prepared so that concentrated hydrochloric acid was at a concentration of 0.8% by mass at 60° C. for 30 minutes (manipulation 2), and further the manipulation 2 was performed once more (manipulation 3). The contact angle with water on the surface of the monomolecular film was measured at every end of the manipulations 1 to 3, and the film thickness of each monomolecular film was measured by ellipsometry after the end of the manipulation 3. The obtained results are shown in the following Table 3.

TABLE 3

| | Contact angle (degree) | | | Film |
|---|---|---|---|---|
| | Manipul. 1 | Manipul. 2 | Manipul. 3 | thickness |
| Example 1 | 75 | 55 | 55 | 2.1 nm |
| Example 2 | 75 | 55 | 55 | 2.1 nm |
| Example 3 | 75 | 55 | 55 | 2.1 nm |
| Example 4 | 75 | 55 | 55 | 2.1 nm |
| Example 5 | 75 | 55 | 55 | 2.1 nm |
| Example 6 | 75 | 55 | 55 | 2.1 nm |
| Example 7 | 75 | 55 | 55 | 2.1 nm |
| Comparative | 65 | 55 | 45 | 1.2 nm |
| Example 1 | | | | |

From the results in Table 3, in the monomolecular film (Comparative Example 1) formed using the silane compound solution containing no nitrogen-containing organic base, the contact angle was confirmed to decrease only by heating in methanol in the manipulation 1, and further confirmed to decrease in all of the manipulations. That is, it is shown in Comparative Example 1 that the monomolecular film was detached in all of the manipulations 1 to 3. The detachment of the monomolecular film in Comparative Example 1 was also confirmed by observing that the film thickness widely decreased after the end of the manipulations 1 to 3.

Meanwhile, in the monomolecular films (Examples 1 to 7) formed using the silane compound solution containing the nitrogen-containing organic base of the present invention, no decrease of the contact angle due to the manipulations 1 to 3 was observed. That is, in Examples 1 to 7, it was confirmed that the monomolecular film was hardly detached when process manipulations, such as the immobilization of the target molecule were performed. This is also supported by the fact that the film thickness was not changed before the manipulation and after the manipulations 1 to 3.

The present invention is not limited to the above embodiments. The above embodiments are exemplifications. Any of those which have substantially the same constitution and have the same effects as technical ideas described in claims of the present invention are included in the technical scope of the present invention.

1. A method for manufacturing a substrate for making a microarray comprising; at least a step of forming a monomolecular film on the substrate using a silane compound, wherein the monomolecular film is formed using a solution comprising the silane compound and a nitrogen-containing organic base in the step.

2. The method for manufacturing the substrate for making the microarray according to claim 1, wherein a nitrogen-containing organic base containing the following structural formula (1) in its structure is used as the nitrogen-containing organic base. 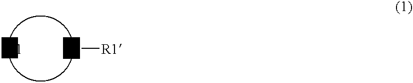
In the formula, R1 represents a linear, cyclic or branched alkylene group having 2-20 carbon atoms and may comprise one or more of a carbonyl group, an ether group, an ester group, and a sulfide group; and R1′ represents hydrogen or a linear or branched alkyl group having 1-25 carbon atoms which may comprise one or more of a carbonyl group, an ether group, an ester group and a lactone ring.

3. The method for manufacturing the substrate for making the microarray according to claim 2, wherein a pyrrolidine derivative or a piperidine derivative is used as the nitrogen-containing organic base.

4. The method for manufacturing the substrate for making the microarray according to claim 1, wherein a molar ratio of the nitrogen-containing organic base to be 0.1 to 100 relative to 1 of the silane compound for a concentration ratio of the nitrogen-containing organic base to the silane compound.

5. The method for manufacturing the substrate for making the microarray according to claim 2, wherein a molar ratio of the nitrogen-containing organic base to be 0.1 to 100 relative to 1 of the silane compound for a concentration ratio of the nitrogen-containing organic base to the silane compound.

6. The method for manufacturing the substrate for making the microarray according to claim 3, wherein a molar ratio of the nitrogen-containing organic base to be 0.1 to 100 relative to 1 of the silane compound for a concentration ratio of the nitrogen-containing organic base to the silane compound.

7. The method for manufacturing the substrate for making the microarray according to claims 1, wherein the microarray is used for analyses of biomolecules.

8. The method for manufacturing the substrate for making the microarray according to claims 2, wherein the microarray is used for analyses of biomolecules.

9. The method for manufacturing the substrate for making the microarray according to claims 3, wherein the microarray is used for analyses of biomolecules.

10. The method for manufacturing the substrate for making the microarray according to claims 4, wherein the microarray is used for analyses of biomolecules.

11. The method for manufacturing the substrate for making the microarray according to claims 5, wherein the microarray is used for analyses of biomolecules.

12. The method for manufacturing the substrate for making the microarray according to claims 6, wherein the microarray is used for analyses of biomolecules.
